(19) United States
(12) Patent Application Publication
(10) Pub. No.: US 2009/0193185 A1
(43) Pub. Date: Jul. 30, 2009

(54) Method for accessing the physical memory of an operating system

(75) Inventor: Yang-Min Cheng, Taipei City (TW)

Correspondence Address: CKC & Partners Co. Lts;12th Fl., Ruttonjee House, 11 Duddell Street, Hong Kong, HK

(73) Assignee: Inventec Corporation

(21) Appl. No.: 12/010,380

(22) Filed: Jan. 24, 2008

(51) Int. Cl. G06F 12/00

(52) U.S. Cl. 711/104; 711/154; 711/E12.001

(57) ABSTRACT

A method for accessing the physical memory with an operating system, providing for mapping the physical address to the linear address of the memory in the operating system. Thus to access the user-space of the memory with an operating system is practically to read and write data in the kernel-space of the memory to achieve quick access of the physical memory.

### BACKGROUND

1. Field of Invention

The present invention relates to a method of accessing the physical memory with an operating system. More particularly, the present invention relates to a method of accessing a Non-Volatile Random Access Memory (NVRAM) with a Linux operating system.

2. Description of Related Art

Operating systems (OS) for embedded systems including Palm OS, Windows CE, and Linux, etc., are widely used. The Linux operating system is the most commonly used because it is free open source software.

The Linux operating system separately accesses two memory segments during operation, the kernel-space and the user-space. Wherein the programs executed in kernel-space are to access and controlling relative hardware, and the general application programs are implemented in the user-space. Since the user-space and the kernel-space are two different memory segments, it is impossible for the user-space to directly access the kernel-space and for the kernel-space to directly access the user-space. A System Call enables the user-space to access the kernel-space or the kernel-space to access the user-space. The System Call checks the caller's authorizations and operations to protect the kernel program. When hardware data is accessed, the operating system leaps through the System Call, such as a driver, from the user-space to the kernel-space.

The static data accessing hardware of an embedded system is applied such as a Flash Memory, a Non-Volatile Random Access Memory (NVRAM), or an Electrically Erasable Programmable Read-Only Memory (EEPROM), wherein the Flash Memory is applied for storing general application programs, as well as the NVRAM and the EEPROM are applied for storing relative surrounding arguments. However, the NVRAM can be accessed without limitations, but the NVRAM cannot be directly accessed after the operating system enters the user-space. As shown in FIG. 1, to read or write the hardware data in the kernel-space 100, a driver is required. That is, after the operating system is loaded and entering into the user-space, a driver is required to access the NVRAM. Therefore, the accessing procedure is complicated and takes a lot of time for accessing the physical memory, when the operating system is loaded in the user-space.

### SUMMARY

For this reason, the present invention provides a method to access the physical memory with an operating system. The method provides mapping the memory addresses of the two separate memory segments in the kernel-space and the user-space. Therefore, the operating system practically reads and writes data in the kernel-space as matter of fact, when it reads and writes to the user-space.

The main idea to this invention is to present a method to quickly access the physical memory with the operating system without any drivers. As shown in FIG. 2, illustrating accessing the kernel-space with the operating system of this invention, when the operating system enters the user-space 200, the operating system can access the data in the physical memory without any drivers with the technique of this invention.

Because of the simple framework in an embedded system, some hardware dispositions are flexible, such that a Non-Volatile Random Access Memory (NVRAM) can be designed corresponding to a certain memory segment. For instance, if assigning the physical address, 0xXXXXXXXX, to the NVRAM, the Linux operating system will access the memory through this address. Then by mapping this address to the memory address of the kernel-space, e.g. 0xYYYYYYYY, the operating system will actually access the NVRAM when referring to the address, 0xYYYYYYYY. Since the user-space and the kernel-space are two different memory segments, the operating system is not capable to access the memory after entering the user-space via the address, 0xYYYYYYYY, as accessing the NVRAM in the kernel-space.

The method for accessing the physical memory with an operating system of the present invention comprises a memory mapping function applied for mapping the linear address of a user-space 200 to the linear address of the kernel-space 100. Thus in fact, the physical memory corresponding to the linear address of the kernel-space 100 is accessed when the operating system accesses the memory in the kernel-space 100. Therefore it is possible to access the NVRAM of an embedded system with the technique of this invention.

### BRIEF DESCRIPTION OF THE DRAWINGS

The invention can be more fully understood by reading the following detailed description of the embodiment, with reference made to the accompanying drawings as follows:

FIG. 1 illustrates accessing the kernel-space by a driver in prior art.

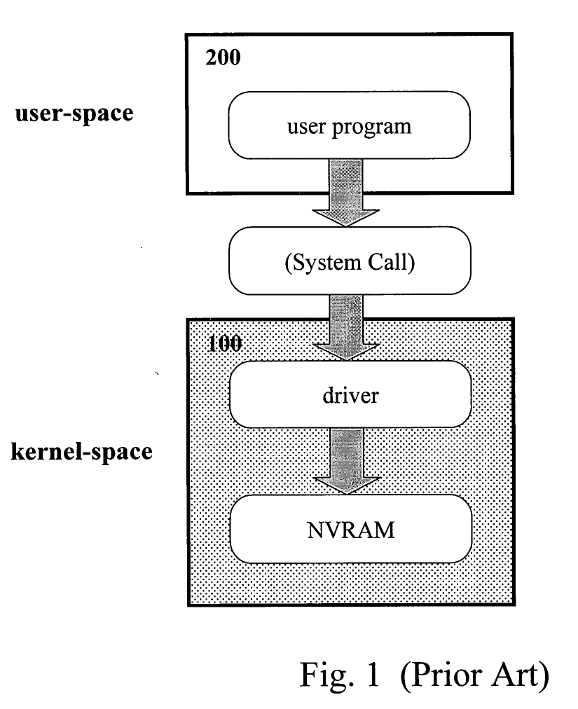

FIG. 2 illustrates accessing the kernel-space with the operating system of this invention.

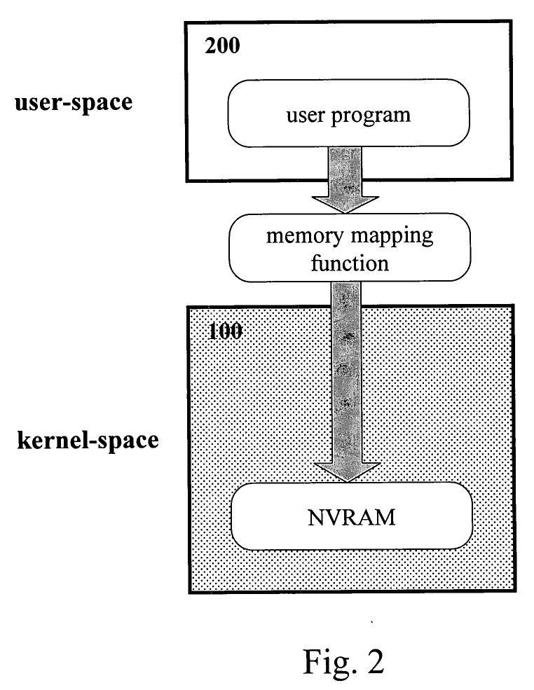

FIG. 3 is the flowchart of accessing the physical memory with the operating system of this invention.

FIG. 4 illustrates a mapping function mapping the linear address of the kernel-space to the linear address of the user-space of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

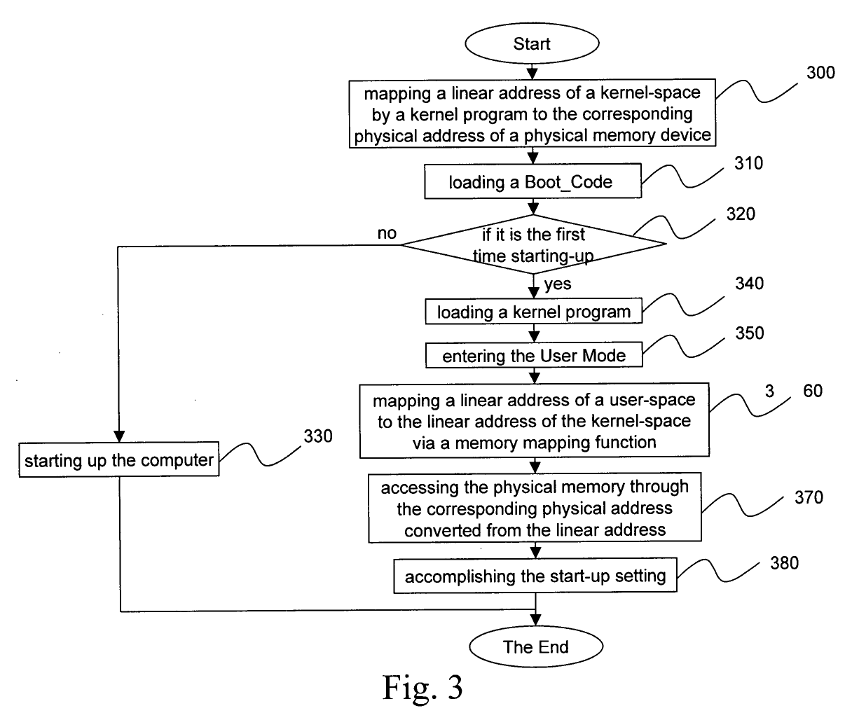

Refer to FIG. 3. FIG. 3 is the flowchart of accessing the physical memory with the operating system of this invention. As shown in FIG. 3, when an operating system starts up a computer, the kernel program of the operating system maps the linear addresses of the kernel-space to the corresponding physical addresses of a physical memory device (Step 300). Wherein the physical addresses are the actual addresses of the physical memory, and the kernel program provides converting and mapping the linear addresses to the physical addresses. After Step 300, the Boot_Code is loaded (Step 310). The Boot_Code is a computer starting-up Bootloader which reads out and loads the kernel program of the operating system. When loading a Boot_Code, the operating system checks if it is the first time starting-up (Step 320). In Step 320, if the system is starting for the first time, the kernel program is loaded (Step 340) to enter the Kernel Mode of the operating system to retrieve the relative hardware conditions. After the kernel program has set the relative hardware conditions in Step 340, the system enters the User Mode (Step 350), to set the other surrounding arguments in the user-space of the operating system. Then in next step, a linear address of a user-space is mapped to the linear address of the kernel-space with a memory mapping function applied by the operating system (Step 360). Therefore, in next step, the application program executed in the User Mode can access the physical memory through the corresponding physical address converted from the linear address (Step 370). After Step 370, the start-up setting of the operating system is accomplished (Step 380), and then the procedure ends up. However, if in Step 340 the operating system does not start up for the first time, the Boot_Code directly starts the computer with the previous system surrounding argument settings (Step 330), and then procedure also ends up.

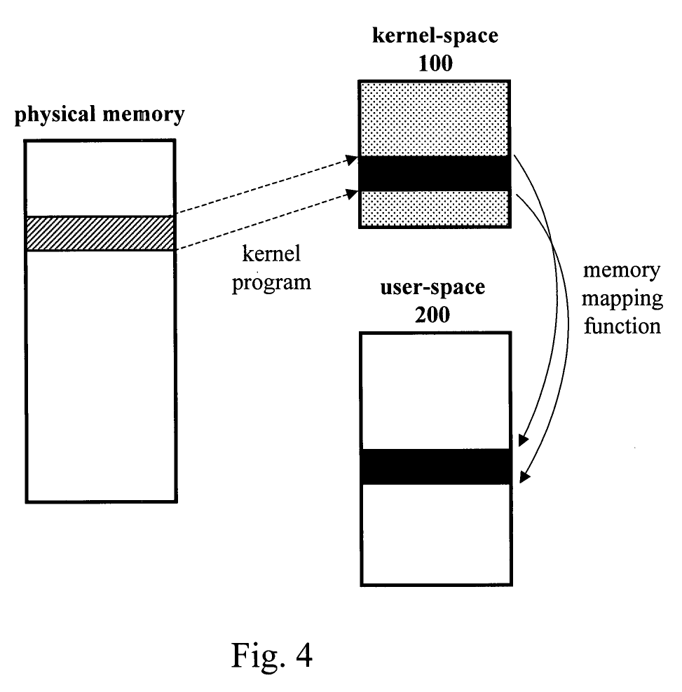

Refer to FIG. 4. FIG. 4 illustrates a mapping function mapping the linear address of the kernel-space to the linear address of the user-space of this invention. As shown in FIG. 4, the above-mentioned memory mapping function in Step 360 is applied for mapping the linear address of the kernel-space 100 to the linear address of the user-space 200. That is, mapping certain data content to the memory. Therefore, accessing a certain memory area in the user-space as accessing the kernel-space, is practically reading or writing the data content on the physical memory device. In fact, the physical memory corresponding to the linear address of the kernel-space 100 is accessed when the operating system accesses the memory in the kernel-space 100. Therefore it is easy to achieve quick access of the physical memory without any drivers.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for accessing the physical memory of an operating system, comprising:
mapping a linear address of a kernel-space to a physical address of a physical memory by a kernel program of an operating system;
mapping a linear address of a user-space to the linear address of the kernel-space with a memory mapping function applied by the operating system; and
accessing the physical memory through the linear address of the user-space.

2. The method for accessing the physical memory of claim 1, wherein the operating system is a Linux operating system.

3. The method for accessing the physical memory of claim 1, wherein the operating system separately accesses the kernel-space and the user-space during operation.

4. The method for accessing the physical memory of claim 1, wherein the physical memory provides memory space for storing kernel program codes and kernel program data.

5. The method for accessing the physical memory of claim 4, wherein the physical memory is a Non-Volatile Random Access Memory (NVRAM).

6. The method for accessing the physical memory of claim 1, wherein the physical address is the real address of the physical memory.

7. The method for accessing the physical memory of claim 1, wherein the linear address is converted by the kernel program to map to the physical address.

8. The method for accessing the physical memory of claim 1, wherein the kernel program is executed in the kernel-space for initiating relative hardware conditions.

9. The method for accessing the physical memory of claim 1, wherein the memory mapping function is applied in the user-space.

10. The method for accessing the physical memory of claim 1, wherein the memory mapping function is applied for mapping the linear address of the kernel-space to the linear address of the user-space.

11. The method for accessing the physical memory of claim 1, whereof accessing the physical memory through the linear address of the user-space is done by converting the linear address to the corresponding physical address by the operating system.

12. A method for accessing the physical memory of a Linux operating system, comprising:
mapping a linear address of a kernel-space to a physical address of a physical memory by a kernel program of a Linux operating system;
mapping a linear address of a user-space to the linear address of the kernel-space with a memory mapping function applied by the Linux operating system; and
accessing the physical memory through the physical address converted from the linear address.

13. The method for accessing the physical memory of claim 12, wherein the Linux operating system separately accesses the kernel-space and the user-space during operation.

14. The method for accessing the physical memory of claim 12, wherein the physical memory provides memory space for storing kernel program codes and kernel program data.

15. The method for accessing the physical memory of claim 12, wherein the physical memory is a Non-Volatile Random Access Memory (NVRAM).

16. The method for accessing the physical memory of claim 12, wherein the physical address is the real address of the physical memory.

17. The method for accessing the physical memory of claim 12, wherein the linear address is converted by the kernel program to map to the physical address.

18. The method for accessing the physical memory of claim 12, wherein the kernel program is executed in the kernel-space for initiating relative hardware conditions.

19. The method for accessing the physical memory of claim 12, wherein the memory mapping function is applied in the user-space.

20. The method for accessing the physical memory of claim 12, wherein the memory mapping function is applied for mapping the linear address of the kernel-space to the linear address of the user-space.
